(19) United States
(12) Patent Application Publication
(10) Pub. No.: US 2016/0316393 A1
(43) Pub. Date: Oct. 27, 2016

(54) QCI Usage and Signaling for IP Flow Selection

(71) Applicant: Spreadtrum Hong Kong Limited, Hong Kong (CN)

(72) Inventors: Anna Pantelidou, Oulu (FI); Hannu Hietalahti, Kiviniemi (FI)

(21) Appl. No.: 14/710,980

(22) Filed: May 13, 2015

Related U.S. Application Data
(60) Provisional application No. 62/153,223, filed on Apr. 27, 2015.
(60) Provisional application No. 62/153,227, filed on Apr. 27, 2015.
(60) Provisional application No. 62/153,218, filed on Apr. 27, 2015.

(51) Int. Cl. H04W 28/08; H04W 28/02; H04W 48/18

(52) U.S. Cl. CPC H04W 28/08; H04W 48/18; H04W 28/0268; H04W 88/06

(57) ABSTRACT

QoS information provided in or by at least one of the RAN and ANDSF for 3GPP compliant mobile networks is or are leveraged to implement IP flow steering rules.

### CROSS-REFERENCE TO RELATED APPLICATION

This application claims the benefit of U.S. Provisional Patent Application Ser. No. 62/153,223, filed 27 Apr. 2015, entitled QCI USAGE AND SIGNALING FOR IP FLOW SELECTION, the entirety of which is hereby incorporated by reference for all purposes. This application claims the benefit of U.S. Provisional Patent Application Ser. No. 62/153,227, filed 27 Apr. 2015, entitled INTRODUCING USER CATEGORIZATION IN CHANNEL ACCESS, the entirety of which is hereby incorporated by reference for all purposes. This application claims the benefit of U.S. Provisional Patent Application Ser. No. 62/153,218, filed 27 Apr. 2015, entitled LTE-WLAN TRAFFIC OFFLOADING ENHANCEMENT USING EXTENDED BSS LOAD ELEMENT, the entirety of which is hereby incorporated by reference for all purposes.

### BACKGROUND

Wireless network operators face various challenges, such as capacity problems as the amount of wireless devices, requiring a large number of connections, is constantly increasing. The technological methods to increase capacity fall short in achieving their target and, as a result, operators observe their networks becoming increasingly congested. One method to alleviate such congestion is mobile data offloading where a particular network is relieved by using complementary network technologies. Such complementary network technologies may include, for example, femto cells, WiMax, LANs and WLANs. One promising technology for doing the offloading is WLAN due to its wide usage, high rate e.g., exceeding 1 Gbps, and the fact that the number of devices supporting WLAN is constantly increasing.

### BRIEF DESCRIPTION OF THE DRAWINGS

FIG. 1 shows a simplified system architecture according to the disclosure.

FIG. 2 shows a first data structure and variant according to the disclosure.

FIG. 3 shows a second data structure and variant according to the disclosure.

FIG. 4 shows a third data structure and variant according to the disclosure.

FIG. 5 shows a fourth data structure according to the disclosure.

FIG. 6 shows a first overview of signal exchange according to the disclosure.

FIG. 7 shows a second overview of signal exchange according to the disclosure.

FIG. 8 shows a third overview of signal exchange according to the disclosure.

FIG. 9 shows a fourth overview of signal exchange according to the disclosure.

FIG. 10 shows a fifth overview of signal exchange according to the disclosure.

FIG. 11 shows a computing system or device according to the disclosure.

### SUMMARY

Although the present disclosure is not so limited, a UE for selectively routing data traffic to one of a 3GPP network and a non-3GPP network is contemplated. The UE may include or comprise: a 3GPP network interface for communicating with the 3GPP network; a non-3GPP network interface for communicating with the non-3GPP network; a processor; and a memory element coupled with and readable by the processor and having stored therein processor-readable instructions that when executed by the processor cause the processor to: detect receipt of a parameter via the 3GPP network interface that identifies a particular mode, selected from a plurality of modes, for selectively routing data traffic to one of the 3GPP network interface and the non-3GPP network interface based on particular QCI information; and route particular data traffic to one of the 3GPP network interface and the non-3GPP network interface according to the particular mode.

Additionally, or alternatively, the particular mode is based on a single QCI parameter, and the particular data traffic is routed to one of the 3GPP network interface and the non-3GPP network interface based upon a comparison by the UE between a value of the single QCI parameter and a particular QCI value associated with the particular data traffic.

Additionally, or alternatively, the one of the 3GPP network and the non-3GPP network is selected based upon a value of a routing parameter of the particular QCI information.

Additionally, or alternatively, the particular mode is based on a range of QCI parameters, and the particular data traffic is routed to one of the 3GPP network interface and the non-3GPP network interface based upon a comparison by the UE between a value of each QCI parameter at the limit of the range of QCI parameters and a particular QCI value associated with the particular data traffic.

Additionally, or alternatively, the one of the 3GPP network and the non-3GPP network is selected based upon a value of a routing parameter of the particular QCI information.

Additionally, or alternatively, the particular mode is based on a set of QCI parameters, and the particular data traffic is routed to one of the 3GPP network interface and the non-3GPP network interface based upon a comparison by the UE between a value of each QCI parameter within the set of QCI parameters and a particular QCI value associated with the particular data traffic.

Additionally, or alternatively, the one of the 3GPP network and the non-3GPP network is selected based upon a value of a routing parameter of the particular QCI information.

Additionally, or alternatively, the QCI information includes a parameter that indicates a number of the QCI parameters within the set of QCI parameters for the UE to identify the QCI parameters within the set of QCI parameters.

Additionally, or alternatively, the particular QCI information comprises a traffic type parameter, a routing parameter, and a QCI parameter, and the particular data traffic is routed to one of the 3GPP network interface and the non-3GPP network interface based upon a value of the routing parameter, a comparison between a value of the traffic type parameter and a particular traffic type value associated with the particular data traffic, and a comparison between a value of the QCI parameter and a particular QCI value associated with the particular data traffic.

Additionally, or alternatively, the memory element having stored therein processor-readable instructions that when executed by the processor cause the processor to: detect receipt of the QCI information via the 3GPP network interface; and store the QCI information to the memory element.

Although the present disclosure is not so limited, a method for selectively routing data traffic to one of a 3GPP network and a non-3GPP network is contemplated. The method may include or comprise: receiving, by a UE, a parameter via a 3GPP network interface that identifies a particular mode, selected from a plurality of modes, for selectively routing data traffic to one of the 3GPP network interface and a non-3GPP network interface based on particular QCI information; and routing, by the UE, particular data traffic to one of the 3GPP network interface and the non-3GPP network interface according to the particular mode.

Additionally, or alternatively, the particular mode is based on a single QCI parameter, and the particular data traffic is routed to one of the 3GPP network interface and the non-3GPP network interface based upon a comparison by the UE between a value of the single QCI parameter and a particular QCI value associated with the particular data traffic.

Additionally, or alternatively, the one of the 3GPP network and the non-3GPP network is selected based upon a value of a routing parameter of the particular QCI information.

Additionally, or alternatively, the particular mode is based on a range of QCI parameters, and the particular data traffic is routed to one of the 3GPP network interface and the non-3GPP network interface based upon a comparison by the UE between a value of each QCI parameter at the limit of the range of QCI parameters and a particular QCI value associated with the particular data traffic.

Additionally, or alternatively, the one of the 3GPP network and the non-3GPP network is selected based upon a value of a routing parameter of the particular QCI information.

Additionally, or alternatively, the particular mode is based on a set of QCI parameters, and the particular data traffic is routed to one of the 3GPP network interface and the non-3GPP network interface based upon a comparison by the UE between a value of each QCI parameter within the set of QCI parameters and a particular QCI value associated with the particular data traffic.

Additionally, or alternatively, the one of the 3GPP network and the non-3GPP network is selected based upon a value of a routing parameter of the particular QCI information.

Additionally, or alternatively, the QCI information includes a parameter that indicates a number of the QCI parameters within the set of QCI parameters for the UE to identify the QCI parameters within the set of QCI parameters.

Additionally, or alternatively, the particular QCI information comprises a traffic type parameter, a routing parameter, and a QCI parameter, and the particular data traffic is routed to one of the 3GPP network interface and the non-3GPP network interface based upon a value of the routing parameter, a comparison between a value of the traffic type parameter and a particular traffic type value associated with the particular data traffic, and a comparison between a value of the QCI parameter and a particular QCI value associated with the particular data traffic.

Additionally, or alternatively, the method may further include or comprise: detecting receipt of the QCI information via the 3GPP network interface; and storing the QCI information to a memory element of the UE.

Although the present disclosure is not so limited, a UE for selectively routing data traffic to one of a 3GPP network and a non-3GPP network is contemplated. The UE may include or comprise: a 3GPP network interface for communicating with the 3GPP network; a non-3GPP network interface for communicating with the non-3GPP network; a processor; and a memory element coupled with and readable by the processor and having stored therein processor-readable instructions that when executed by the processor cause the processor to: selectively route data traffic to one of the 3GPP network interface and the non-3GPP network interface based on QCI indication information received by the UE via the 3GPP network interface, wherein the QCI indication information includes at least one parameter selected from the group consisting of: at least one particular QCI parameter; an action parameter; a traffic-type parameter; and a scheme selection parameter.

3GPP: 3^{rd} Generation Partnership Project.

ANDSF: Access Network Discovery and Selection Function.

AP: Access Point.

BSS: Basic Service Set.

BSSID: Basic Service Set Identifier.

(e)NB or eNB: (enhanced) Node B.

HESSID: Homogeneous Extended Service Set Identifier.

GBR: Guaranteed Bit Rate.

Gbps: Gigabit Per Second.

HESSID: Homogeneous Extended Service Set Identifier.

Non-GBR: Non-Guaranteed Bit Rate.

QoS: Quality of Service.

QCI: QoS Class Indicator.

RAN: Radio Access Network.

SSID—Service Set Identifier.

TSM: Traffic Steering Module.

UE: User Equipment.

WAN—Wide Area Network.

WLAN: Wireless Local Area Network.

Further areas of applicability of the present disclosure will become apparent from the detailed description provided hereinafter. It should be understood that the above summary, and the following detailed description and specific examples, while indicating various embodiments, are intended for purposes of illustration only and are not intended to necessarily limit the scope of the disclosure.

### DETAILED DESCRIPTION

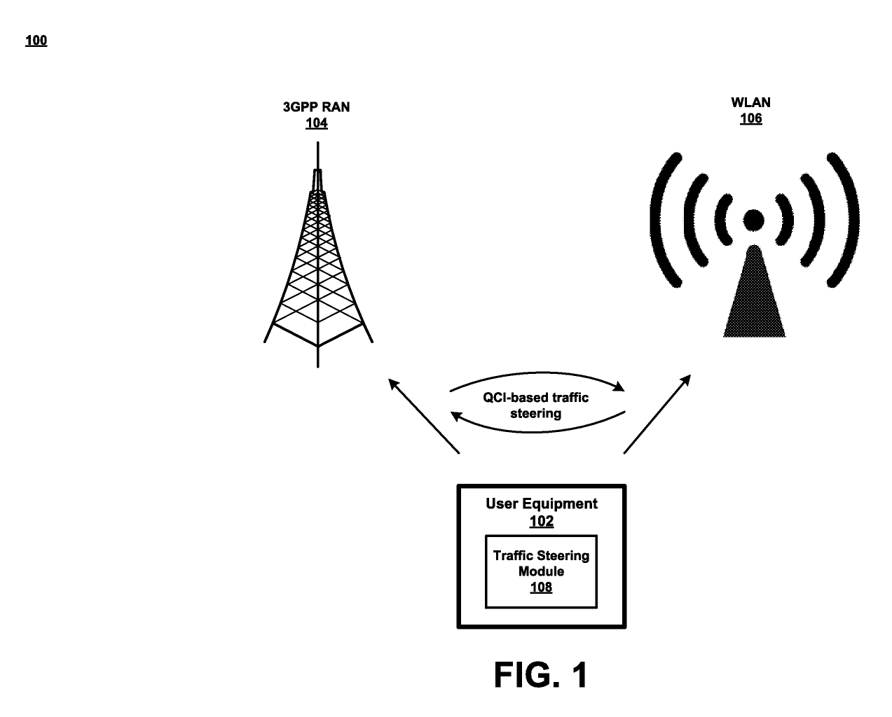

The present disclosure is directed to or towards 3GPP/non-3GPP interworking and IP flow mobility. It is contemplated that when a UE has access to two technologies, e.g., access to a 3GPP network and to a WLAN network, traffic may be steered from one network to the other using QCI or in general QoS information. More specifically, it is contemplated that 3GPP network related QoS information in the RAN and/or ANDSF may be leveraged to implement IP flow steering rules. For example, and referring now to FIG. 1, an example simplified system architecture 100 is shown. In this example, when UE 102 is served by 3GPP network 104 and WLAN network 106 is access available, TSM 108 of UE 102 may steer or offload particular traffic from 3GPP network 104 to WLAN network 106. It is contemplated that the decision to steer or offload such traffic may be based on QoS information received by the UE 102 via RAN level signaling or provided in or by the ANDSF from 3GPP network 104. Alternatively, when UE 102 is served by WLAN network 106, but moves out of network coverage for example, a transfer or handoff of particular traffic may occur back to 3GPP network 104. Again, it is contemplated that the decision to steer or offload such traffic may be based on QoS information received by the UE 102 via RAN level signaling or provided in or by the ANDSF from 3GPP network 104. In this manner, QoS information in the RAN and/or ANDSF may be leveraged to implement IP flow steering rules. Although the present disclosure is not limited to a specific implementation or technology, an example of such QoS information may include or comprise QCI information as standardized in 3GPP specification TS23.203:

TABLE 1
Standardized QCI characteristics

| | | | Packet | Packet Error | |
|---|---|---|---|---|---|
| | Resource | Priority | Delay | Loss Rate | |
| QCI | Type | Level | Budget | (NOTE 2) | Example Services |
| 1 | | 2 | 100 ms | 10-2 | Conversational Voice |
| (NOTE 3) | | | (NOTE 1, | | |
| | | | NOTE 11) | | |
| 2 | GBR | 4 | 150 ms | 10-3 | Conversational Video (Live |
| (NOTE 3) | | | (NOTE 1, | | Streaming) |
| | | | NOTE 11) | | |
| 3 | | 3 | 50 ms | 10-3 | Real Time Gaming |
| (NOTE 3) | | | (NOTE 1, | | |
| | | | NOTE 11) | | |
| 4 | | 5 | 300 ms | 10-6 | Non-Conversational Video (Buffered |
| (NOTE 3) | | | (NOTE 1, | | Streaming) |
| | | | NOTE 11) | | |
| 65 | | 0.7 | 75 ms | 10-2 | Mission Critical user plane Push To |
| (NOTE 3, | | | (NOTE 7, | | Talk voice (e.g., MCPTT) |
| NOTE 9) | | | NOTE 8) | | |
| 66 | | 2 | 100 ms | 10-2 | Non-Mission-Critical user plane |
| (NOTE 3) | | | (NOTE 1, | | Push To Talk voice |
| | | | NOTE 10) | | |
| 5 | | 1 | 100 ms | 10-6 | IMS Signalling |
| (NOTE 3) | | | (NOTE 1, | | |
| | | | NOTE 10) | | |
| 6 | | 6 | 300 ms | 10-6 | Video (Buffered Streaming) |
| (NOTE 4) | | | (NOTE 1, | | TCP-based (e.g., www, e-mail, chat, |
| | | | NOTE 10) | | ftp, p2p file sharing, progressive |
| | | | | | video, etc.) |
| 7 | Non- | 7 | 100 ms | 10-3 | Voice, |
| (NOTE 3) | GBR | | (NOTE 1, | | Video (Live Streaming) |
| | | | NOTE 10) | | Interactive Gaming |
| 8 | | 8 | 300 ms | 10-6 | Video (Buffered Streaming) |
| (NOTE 5) | | | | | TCP-based (e.g., www, e-mail, chat, |
| | | | | | ftp, p2p file |
| 9 | | 9 | (NOTE 1, | | sharing, progressive video, etc.) |
| (NOTE 6) | | | NOTE 10) | | |
| 69 | | 0.5 | 60 ms | 10-6 | Mission Critical delay sensitive |
| (NOTE 3, | | | (NOTE 7, | | signalling (e.g., MC-PTT signalling) |
| NOTE 9) | | | NOTE 8) | | |
| 70 | | 5.5 | 200 ms | 10-6 | Mission Critical Data (e.g. example |
| (NOTE 4) | | | (NOTE 7, | | services are the same as QCI 6/8/9) |
| | | | NOTE 10) | | |

NOTE 1:
A delay of 20 ms for the delay between a PCEF and a radio base station should be subtracted from a given PDB to derive the packet delay budget that applies to the radio interface. This delay is the average between the case where the PCEF is located “close” to the radio base station (roughly 10 ms) and the case where the PCEF is located “far” from the radio base station, e.g. in case of roaming with home routed traffic (the one-way packet delay between Europe and the US west coast is roughly 50 ms). The average takes into account that roaming is a less typical scenario. It is expected that subtracting this average delay of 20 ms from a given PDB will lead to desired end-to-end performance in most typical cases. Also, note that the PDB defines an upper bound. Actual packet delays - in particular for GBR traffic - should typically be lower than the PDB specified for a QCI as long as the UE has sufficient radio channel quality.
NOTE 2:
The rate of non congestion related packet losses that may occur between a radio base station and a PCEF should be regarded to be negligible. A PELR value specified for a standardized QCI therefore applies completely to the radio interface between a UE and radio base station.
NOTE 3:
This QCI is typically associated with an operator controlled service, i.e., a service where the SDF aggregate's uplink/downlink packet filters are known at the point in time when the SDF aggregate is authorized. In case of E-UTRAN this is the point in time when a corresponding dedicated EPS bearer is established/modified.
NOTE 4:
If the network supports Multimedia Priority Services (MPS) then this QCI could be used for the prioritization of non real-time data (i.e. most typically TCP-based services/applications) of MPS subscribers.
NOTE 5:
This QCI could be used for a dedicated “premium bearer” (e.g. associated with premium content) for any subscriber/subscriber group. Also in this case, the SDF aggregate's uplink/downlink packet filters are known at the point in time when the SDF aggregate is authorized. Alternatively, this QCI could be used for the default bearer of a UE/PDN for “premium subscribers”.
NOTE 6:
This QCI is typically used for the default bearer of a UE/PDN for non privileged subscribers. Note that AMBR can be used as a “tool” to provide subscriber differentiation between subscriber groups connected to the same PDN with the same QCI on the default bearer.
NOTE 7:
For Mission Critical services, it may be assumed that the PCEF is located “close” to the radio base station (roughly 10 ms) and is not normally used in a long distance, home routed roaming situation. Hence delay of 10 ms for the delay between a PCEF and a radio base station should be subtracted from this PDB to derive the packet delay budget that applies to the radio interface.
NOTE 8:
In both RRC Idle and RRC Connected mode, the PDB requirement for these QCIs can be relaxed (but not to a value greater than 320 ms) for the first packet(s) in a downlink data or signalling burst in order to permit reasonable battery saving (DRX) techniques.
NOTE 9:
It is expected that QCI-65 and QCI-69 are used together to provide Mission Critical Push to Talk service (e.g., QCI-5 is not used for signalling for the bearer that utilizes QCI-65 as user plane bearer). It is expected that the amount of traffic per UE will be similar or less compared to the IMS signalling.
NOTE 10:
In both RRC Idle and RRC Connected mode, the PDB requirement for these QCIs can be relaxed for the first packet(s) in a downlink data or signalling burst in order to permit battery saving (DRX) techniques.
NOTE 11:
In RRC Idle mode, the PDB requirement for these QCIs can be relaxed for the first packet(s) in a downlink data or signalling burst in order to permit battery saving (DRX) techniques.

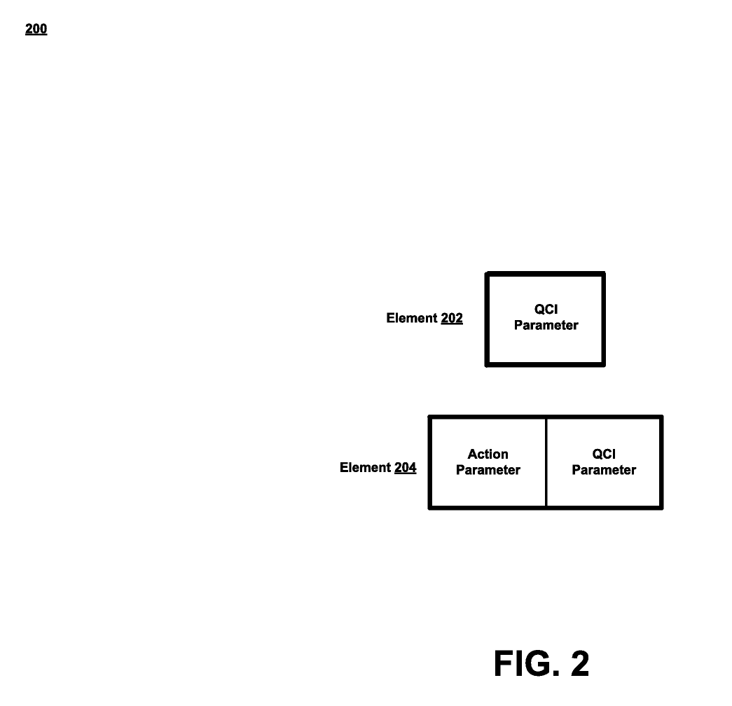

In this example, and referring now additionally to FIG. 2, a first example data structure 200 is shown. It is contemplated that a single QCI Parameter may be indicated and used in the RAN level and/or ANDSF for traffic steering, as shown at element 202. In practice, UE 102 may interpret this parameter as a threshold below which particular traffic is not offloaded to WLAN network 106, i.e., UE 102 always stays in 3GPP access, and above which particular traffic is offloaded to WLAN network 106. For example, by indicating QCI=2 in or at element 202, all conversational voice traffic with Priority 2 is guaranteed to be served by 3GPP network 104, i.e., all traffic with QCI<2, and all non-GBR traffic and GBR traffic of QCI≧2 may be offloaded to WLAN network 106. The present disclosure however is not so limited. In particular, interpreting how to handle different QCI parameters may be either fixed and specified or further indicated.

For example, as shown at element 204 of FIG. 2, an Action Parameter may be used to indicate or instruct TSM 108 of UE 102 how to handle a given QCI parameter(s), i.e., whether or not to offload particular traffic to WLAN network 106. In this example, it is contemplated that a single bit may be used to indicate the Action: Offload=1 (or 0); Do Not Offload=0 (or 1). Here, and when enforced, when Action Parameter=0 all traffic flows with QCI indicated by QCI Parameter in or at element 204 will not be offloaded to WLAN network 106, and when Action Parameter=1 all those traffic flows will be offloaded to WLAN network 106. As suggested, the value of Action Parameter that triggers offloading or not is exemplary, the values of 0 and 1 may be interchanged. Other example data structures are contemplated as well.

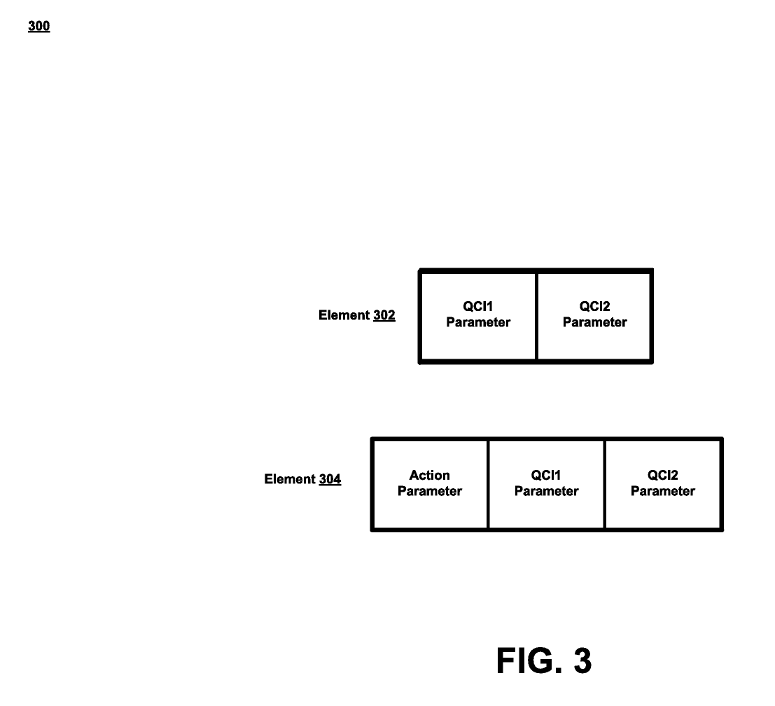

For example, and referring now to FIG. 3, a second example data structure 300 is shown. It is contemplated that a consecutive or ordered range of QCI parameters may be indicated and used in the RAN level and/or ANDSF for traffic steering, as shown at element 302. In practice, UE 102 may interpret this range so that an Action, i.e., offloading or not to WLAN network 106, may take place for each QCI parameter in the range [QCI1, QCI2], inclusive. Additionally, an Action Parameter as shown at element 304 may be used to indicate or instruct TSM 108 of UE 102 how to handle a given QCI parameter(s), i.e., whether or not to offload particular traffic to WLAN network 106, in a manner similar to that discussed above in connection with FIG. 2. For example, when Action Parameter=1, all traffic flows with QCIs in the range [5, 9], corresponding to non-GBR traffic, will be offloaded to WLAN network 106 and, when Action Parameter=0, all those traffic flows will not be offloaded to WLAN network 106. As mentioned above, the bit values 1 and 0 can be used interchangeably to indicate offloading or not of traffic satisfying a given QCI condition. Still other data structures are contemplated as well.

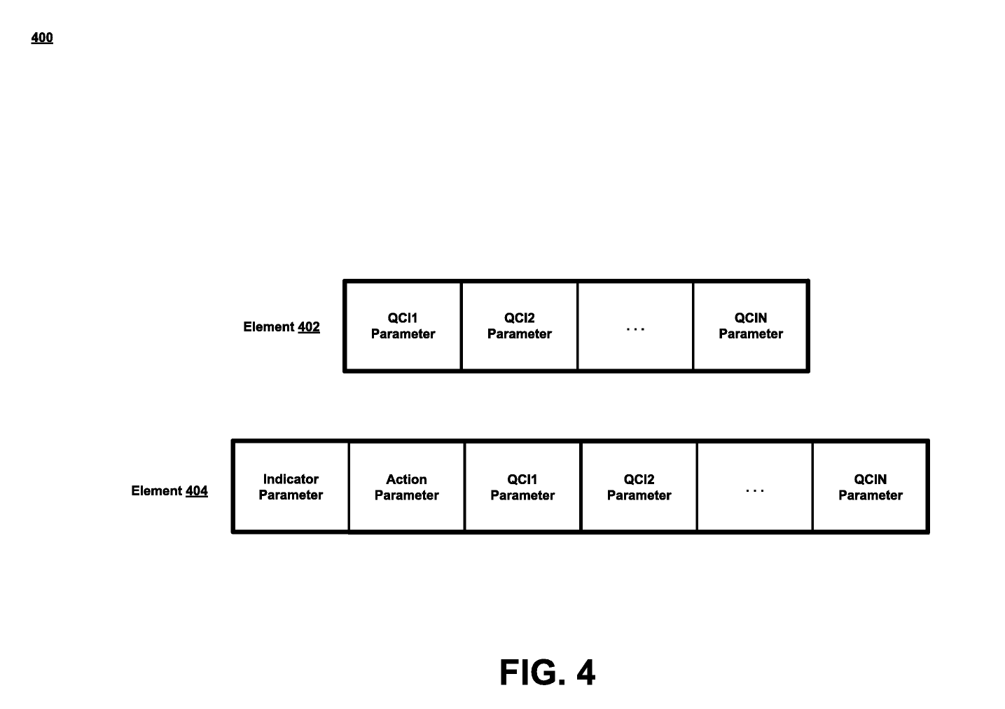

For example, and referring now to FIG. 4, a third example data structure 400 is shown. It is contemplated that a non-consecutive set of QCI parameters may be indicated and used in the RAN level and/or ANDSF for traffic steering, as shown at element 402. In practice, UE 102 may interpret this set so that an Action, offloading or not to WLAN network 106, may take place for each QCI parameter in the set [QCI1, QCI2, . . . , QCIN]. Additionally, an Action Parameter as shown at element 404 may be used to indicate or instruct TSM 108 of UE 102 how to handle a given QCI parameter(s), i.e., whether or not to offload particular traffic to WLAN network 106, in a manner similar to that discussed above in connection with FIG. 2 and FIG. 3. For example, when Action Parameter=1, all traffic flows with QCIs in the set [QCI1, QCI2, . . . , QCIN] will not be offloaded to WLAN network 106 and, when Action Parameter=0, all those traffic flows will be offloaded to WLAN network 106. Additionally, an Indicator Parameter as shown at element 404 may be leveraged to indicate to the UE 102 the number, i.e., integer value N, of QCI parameters included at element 404.

All modes of indication as shown and discussed in connection with FIGS. 2-4, i.e., single parameter, range, and set, may be supported by the system in the RAN or in the ANDSF management object. It is contemplated that which one is in use at any given time may be indicated by using, for example, 2 bits as: bit value 00=single QCI parameter as shown and discussed in connection with FIG. 2; bit value 01=range of QCI parameters in the form [QCI1, QCI2] as shown and discussed in connection with FIG. 3; bit value 10=set of QCI parameters in the form [QCI1, QCI2, . . . , QCIn] as shown and discussed in connection with FIG. 4; and bit value 11=Reserved. Still other data structures are contemplated as well.

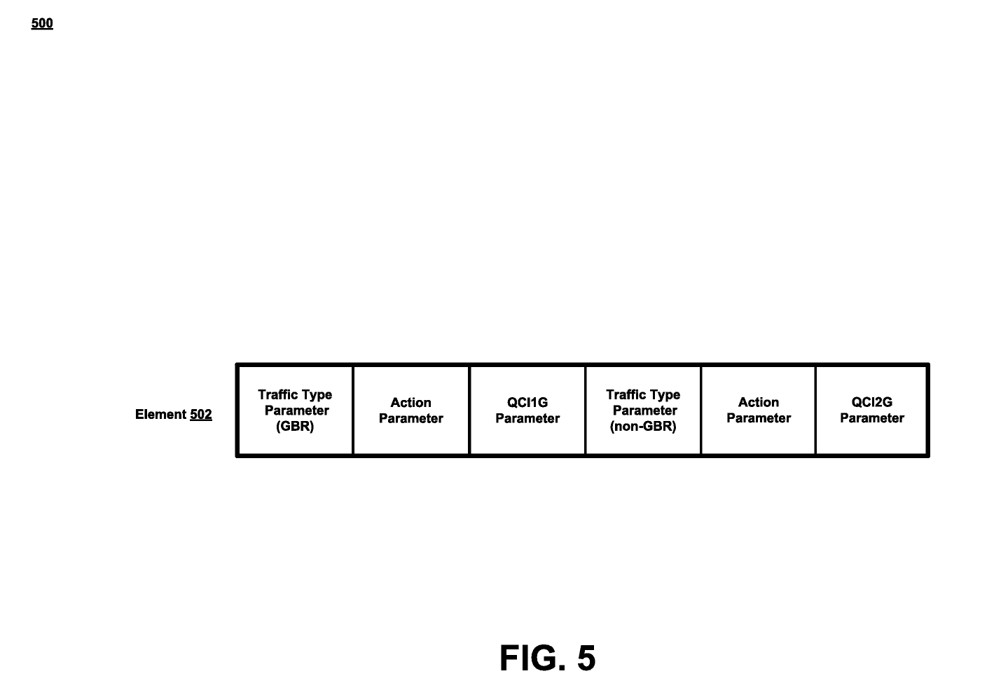

For example, and referring now to FIG. 5, a fourth example data structure 500 is shown. In this example, it is contemplated that QCI parameters may be indicated per traffic type, i.e., GBR or non-GBR, in the RAN and/or in the ANDSF, as shown at element 502. For example, when Traffic Type Parameter=1, the fields that follow, e.g., Action Parameter and QCI Parameter, relate to an Action that should be applied for QCIs indicated as GBR traffic type, and when GBR=0 a similar implementation applies for non-GBR traffic types. Here, it will be appreciated that the positions of different fields within example element 502 are only exemplary. For instance, Action Parameter and traffic type (GBR versus non-GBR) may be inter-changed. Still other data structures are contemplated as well.

For example, and in the context of the above discussion in connection with FIGS. 2-5, it is contemplated that more or additional bits may be used or utilized to indicate Action and Indicator parameters. For example, a 3 bit implementation may be utilized or defined as: bit value 000=single QCI parameter; bit value 001=single QCI parameter with Action parameter; bit value 010=range of QCI parameter; bit value 011=range of QCI parameters with Action parameter; bit value 100=set of QCI parameters; bit value 101: set of QCI parameters with Action parameter; bit value 110=set of QCI parameters with Indicator parameter indication; and bit value 111=set of QCI parameters with Action parameter and Indicator parameter indication. Still other examples are possible

For example, an additional bit may be used or utilized to indicate whether reference is to GBR traffic or to non-GBR traffic. For example, a 4 bit implementation may be utilized or defined as: bit value 0000=single QCI parameter for non-GBR traffic; bit value 0001=single QCI parameter with Action parameter for non-GBR traffic; bit value 0010=range of QCI parameters for non-GBR traffic; bit value 0011=range of QCI parameters with Action parameter for non-GBR traffic; bit value 0100=set of QCI parameters for non-GBR traffic; bit value 0101=set of QCI parameters with Action parameter for non-GBR traffic; bit value 0110=set of QCI parameters with Indicator parameter for non-GBR traffic; bit value 0111=set of QCI parameters with Action parameter and Indicator parameter for non-GBR traffic.

Additionally, bit value 1000=single QCI parameter for GBR traffic; bit value 1001=single QCI parameter with Action parameter for GBR traffic; bit value=1010: range of QCI parameters for GBR traffic; bit value 1011=range of QCI parameters with Action parameter for GBR traffic; bit value 1100=set of QCI parameters for GBR traffic; bit value 1101=set of QCI parameters with Action parameter for GBR traffic; bit value 1110=set of QCI parameters with Indicator Parameter for GBR traffic; bit value 1111=set of QCI parameters with Action parameter and Indicator parameter for GBR traffic. Fewer bits may be used to indicate only a subset of all these options given by 4 bits.

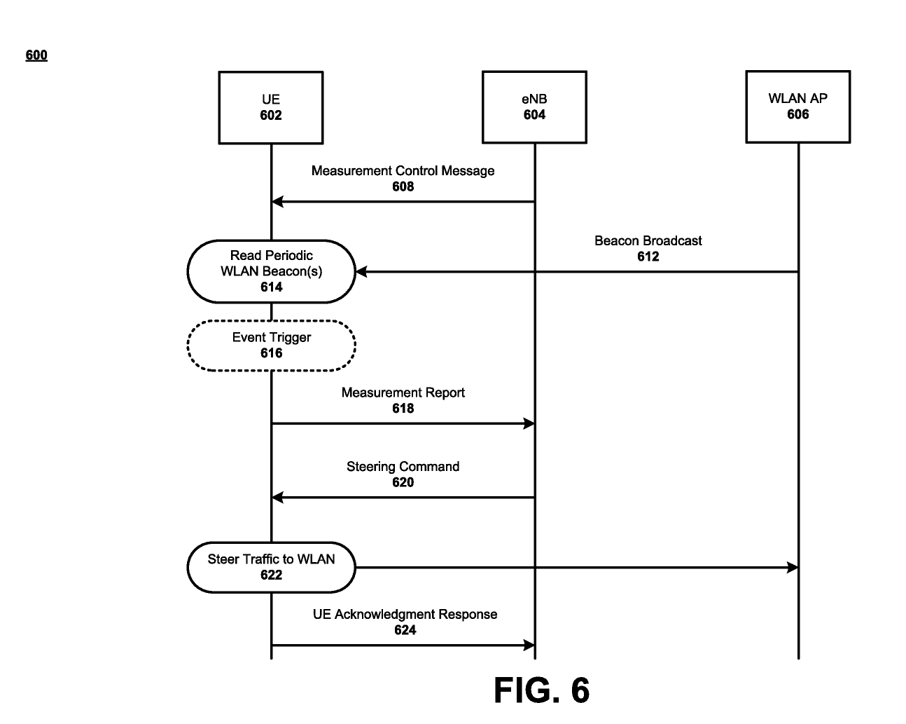

Referring now collectively to FIGS. 6-10, various signaling schemes for identifying appropriate instances for offloading or steering data traffic from a mobile device to a WLAN are shown in accordance with the principles of the present disclosure. Similar schemes are described in U.S. Nonprovisional Patent Application Ser. No. 14/710,816, entitled LTE-WLAN TRAFFIC OFFLOADING ENHANCEMENT USING EXTENDED BSS LOAD ELEMENT, filed on even date herewith, the entirety of which is hereby incorporated by reference for all purposes.

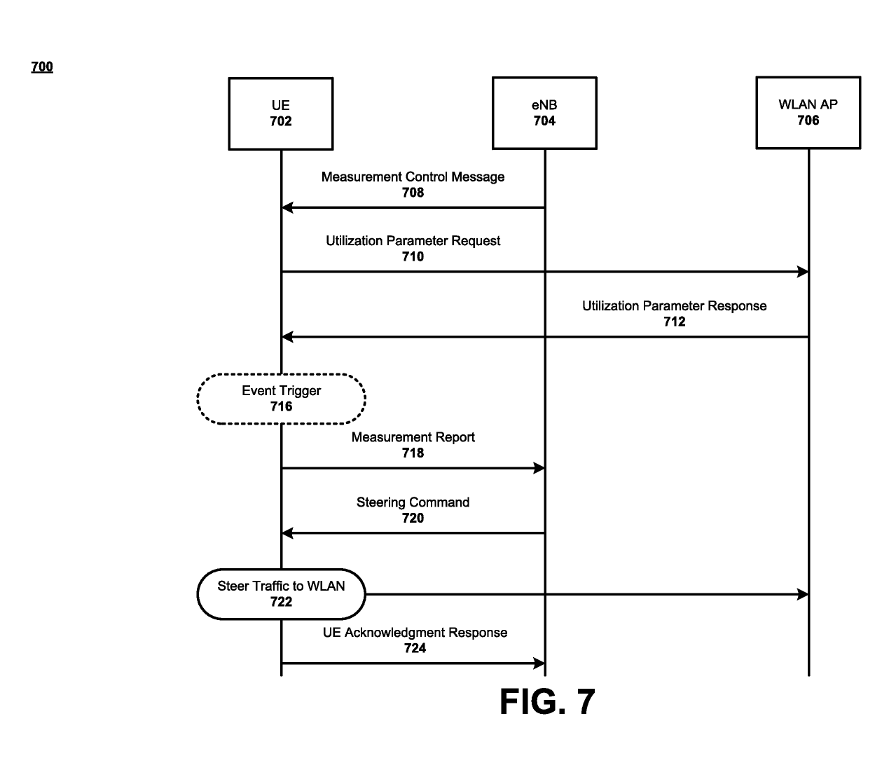

As discussed throughout, QCI information may be collected either from the RAN or from the operator defined ANDSF management object. FIGS. 6-10 in particular illustrate how such QCI information is propagated at a UE. For example, in FIG. 6, which illustrates to network-based offloading, an eNB in a measurement control message may send information that involves a network selection process. If the network is found to be a good candidate, e.g., based on the information in the measurement report when received by the eNB, then in the steering command it can indicate which flows, corresponding to some QCIs, to offload, i.e., the QCI rules. This can be done for example in the steering command message. Alternatively, the QCI rules may be sent in the measurement control message already. FIG. 7 in contrast illustrates UE-based traffic offloading. Since in this case the UE decides the network selection and traffic offloading rules an eNB may send the QCI rules in the measurement control message. Then the UE after receiving the beacon in combination with the QCI or other information from the measurement control message may decide whether to steer traffic or not and, if so, it identifies the flows corresponding to different QCIs that will be offloaded to the WLAN AP.

In more detail, with reference to FIG. 6, a measurement control message 608 is transmitted by a cellular WAN, such as eNB 604, and received by a mobile device, such as UE 602. In embodiments, measurement control message 608 direct UE 602 to generate measurement report 618, for example a single time as a response to a measurement control message and/or periodically upon a preconfigured time period elapsing. Optionally, measurement control message 608 identifies a target WLAN, such as WLAN AP 606. For example, the WLAN AP 606 may be identified by one or more of operating class, channel number, BSSID, SSID, HESSID, and the like.

Optionally, measurement control message 608 includes threshold information, such as a minimum or maximum spectral utilization for which a measurement report is requested. Optionally, multiple thresholds may be provided, such as one per channel utilization (e.g., primary 20 MHz, secondary 20 Hz, secondary 40 MHz, and secondary 80 MHz). Threshold information is optionally used to request an indication as to whether a specified threshold is exceeded or not (e.g. a false/true or 0/1 indication) or to request information for spectral utilization that falls above the threshold or spectral utilization that falls below the threshold.

Optionally, measurement control message 608 provides threshold information for previous measurements. For example, previous measurement threshold information is optionally provided so that the measurement report may include knowledge of whether the threshold was exceeded for any previous measurement. This information is useful, in embodiments, for example, for determining whether it may be appropriate to steer traffic from UE 602 to WLAN AP 606.

In embodiments, receiving measurement control message 608 at UE 602 causes UE 602 to identify wireless spectrum utilization. As illustrated, UE 602 receives beacon broadcasts 612 from WLAN AP 606 and reads periodic WLAN beacons at 614. Information from the periodic WLAN beacons is then used to identify wireless spectrum utilization for generation of measurement report 618.

Optionally, event trigger 616 indicates when measurement report 618 is to be sent to eNB 604. Event trigger 616 can optionally make use of thresholding. Upon receiving measurement report 618, eNB 604 transmits steering command 620 to UE 602 if WLAN AP 606 has sufficient availability. UE 602 uses steering command 620 to determine that traffic is to be steered to WLAN AP 606. At 622, UE 602 steers traffic to WLAN AP 606. Further, UE 602 optionally transmits acknowledgement response 624 to eNB 604 in response to steering command 620.

In FIG. 7, measurement control message 708 is transmitted by a cellular WAN, such as eNB 704, and received by a mobile device, such as UE 702. In embodiments, measurement control message 708 direct UE 702 to generate measurement report 718, for example a single time as a response to a measurement control message and/or periodically upon a preconfigured time period elapsing. Optionally, measurement control message 708 identifies a target WLAN, such as WLAN AP 706. For example, the WLAN AP 706 may be identified by one or more of operating class, channel number BSSID, SSID, HESSID, and the like.

Optionally, measurement control message 708 includes threshold information, such as a minimum or maximum spectral utilization for which a measurement report is requested. Optionally, multiple thresholds may be provided, such as one per channel utilization (e.g., primary 20 MHz, secondary 20 Hz, secondary 40 MHz, and secondary 80 MHz). Threshold information is optionally used to request an indication as to whether a specified threshold is exceeded or not (e.g. a false/true or 0/1 indication) or to request information for spectral utilization that falls above the threshold or spectral utilization that falls below the threshold.

Optionally, measurement control message 708 provides threshold information for previous measurements. For example, previous measurement threshold information is optionally provided so that the measurement report may include knowledge of whether the threshold was exceeded for any previous measurement. This information is useful, in embodiments, for example, for determining whether it may be appropriate to steer traffic from UE 702 to WLAN AP 706.

In embodiments, receiving measurement control message 708 at UE 702 causes UE 702 to transmit utilization parameter request 710. In response, WLAN AP 706 transmits utilization parameter response 712 that identifies wireless spectrum utilization. The wireless spectrum utilization information is then used for generation of measurement report 718.

Optionally, event trigger 716 indicates when measurement report 718 is to be sent to eNB 704. Event trigger 716 can optionally make use of thresholding. Upon receiving measurement report 718, eNB 704 transmits steering command 720 to UE 702 if WLAN AP 706 has sufficient availability. UE 702 uses steering command 720 to determine that traffic is to be steered to WLAN AP 706. At 722, UE 702 steers traffic to WLAN AP 706. Further, UE 702 optionally transmits an acknowledgement response 724 to eNB 704 in response to steering command 720.

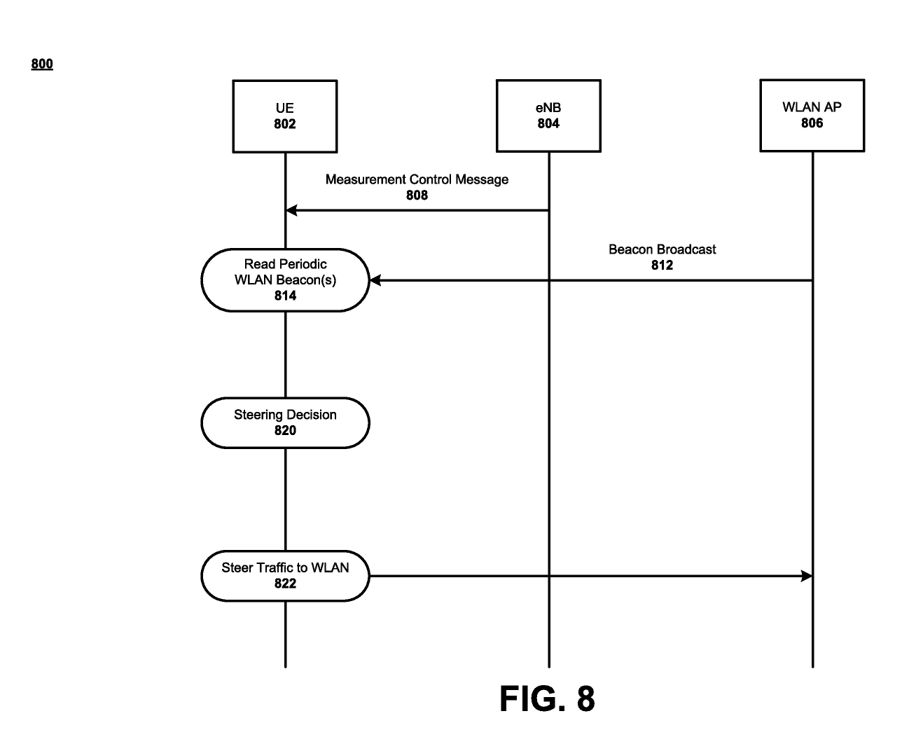

In FIG. 8, measurement control message 808 is transmitted by a cellular WAN, such as eNB 804, and received by a mobile device, such as UE 802. Optionally, measurement control message 808 identifies a target WLAN, such as WLAN AP 806. For example, WLAN AP 806 may be identified by one or more of operating class, channel number BSSID, SSID, HESSID, and the like. In embodiments, measurement control message 808 direct UE 802 to self-determine when to steer traffic to WLAN AP 806. In embodiments, receiving measurement control message 808 at UE 802 causes UE 802 to identify wireless spectrum utilization. As illustrated, UE 802 receives beacon broadcasts 812 from WLAN AP 806 and reads periodic WLAN Beacons at 814, such as may include an element describing spectrum utilization. Information from the periodic WLAN beacons is then used to identify wireless spectrum utilization for generation of measurement report 818.

Optionally, measurement control message 808 includes threshold information, such as a minimum or maximum spectral utilization for which steering traffic from UE 802 to WLAN AP 806 may be appropriate. Optionally, multiple thresholds may be provided, such as one per channel utilization (e.g., primary 20 MHz, secondary 20 Hz, secondary 40 MHz, and secondary 80 MHz).

Optionally, measurement control message 808 provides threshold information for previous measurements. For example, previous measurement threshold information is optionally provided so that UE 802 can utilize information regarding whether the threshold was exceeded for any previous measurement in determining whether it may be appropriate to steer traffic from UE 802 to WLAN AP 806.

Upon determining that WLAN AP 806 has sufficient availability, UE 802 makes steering decision 820 to determine that traffic is to be steered to WLAN AP 806. Steering decision 820 may optionally make use of thresholding, as described above. At 822, UE 802 steers traffic to WLAN AP 806.

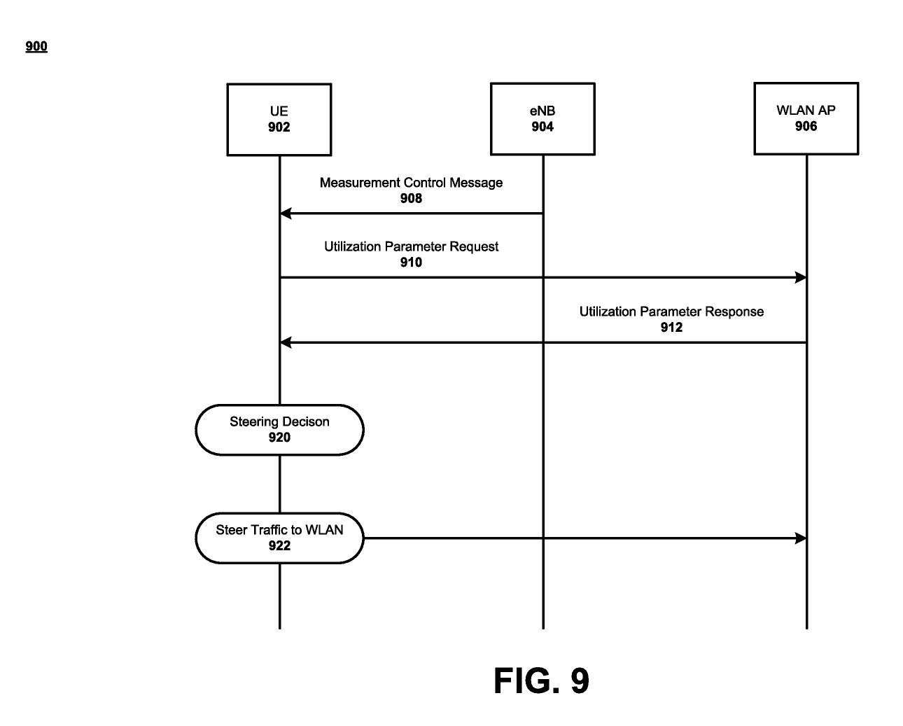

In FIG. 9, measurement control message 908 is transmitted by a cellular WAN, such as eNB 904, and received by a mobile device, such as UE 902. Optionally, measurement control message 908 identifies a target WLAN, such as WLAN AP 906. For example, WLAN AP 906 may be identified by one or more of operating class, channel number BSSID, SSID, HESSID, and the like. In embodiments, measurement control message 908 direct UE 902 to self-determine when to steer traffic to WLAN AP 906. In embodiments, receiving measurement control message 908 at UE 902 causes UE 902 to transmit utilization parameter request 910. In response, WLAN AP 906 transmits utilization parameter response 912 that identifies wireless spectrum utilization.

Optionally, measurement control message 908 includes threshold information, such as a minimum or maximum spectral utilization for which steering traffic from UE 902 to WLAN AP 906 may be appropriate. Optionally, multiple thresholds may be provided, such as one per channel utilization (e.g., primary 20 MHz, secondary 20 Hz, secondary 40 MHz, and secondary 80 MHz).

Optionally, measurement control message 908 provides threshold information for previous measurements. For example, previous measurement threshold information is optionally provided so that UE 902 can utilize information regarding whether the threshold was exceeded for any previous measurement in determining whether it may be appropriate to steer traffic from UE 902 to WLAN AP 906.

Upon determining that WLAN AP 906 has sufficient availability, such as based on the received utilization parameter response 912, UE 902 makes steering decision 920 to determine that traffic is to be steered to WLAN AP 906. Steering decision 920 may optionally make use of thresholding. At 922, UE 902 steers traffic to WLAN AP 906.

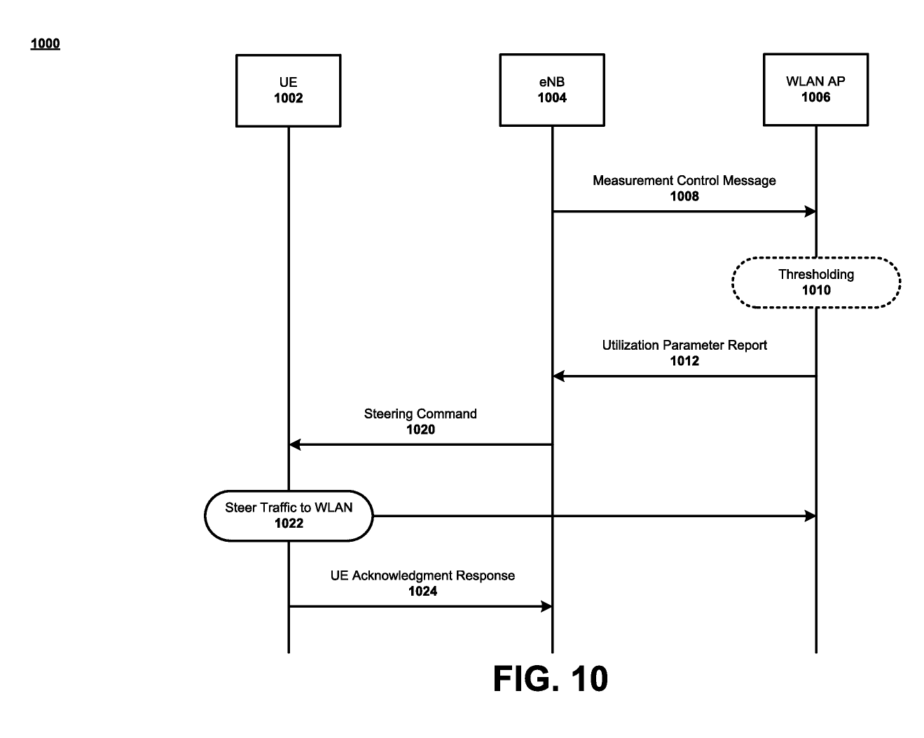

In FIG. 10, measurement control message 1008 is transmitted by a cellular WAN, such as eNB 1004, and received by a WLAN AP, such as WLAN AP 1006. Measurement control message 1008 may include a utilization parameter request. Optionally, at 1010, threshold levels may be determined and upon determining that WLAN 1006 has sufficient availability or the spectrum utilization is below a specified threshold, WLAN AP 1006 may transmit a utilization parameter report 1012. If thresholding is not applied, the WLAN AP 1006 transmits the utilization parameter report 1012, which is received by eNB 1004.

eNB 1004 may then use utilization parameter report 1012 to determine if WLAN AP has sufficient availability. Upon such a determination, eNB 904 transmits steering command 1020 to a mobile device, such as UE 1002. UE 1002 uses steering command 1020 to determine that traffic is to be steered to WLAN AP 1006. At 1022, UE 1002 steers traffic to WLAN AP 1006. Further, UE 1002 optionally transmits acknowledgement response 1024 to eNB 1004 in response to steering command 1020.

Advantageously, such an implementation(s) as contemplated throughout provides an example of how to use QCI parameters in the RAN and in the ANDSF in order to perform IP flow selection for offloading. Other examples are possible. For example, if UE 102 supports ANDSF, it is contemplated that the ANDSF management object data structure may be enhanced to include a QCI parameter(s), or QCI parameter value range, as described for RAN rules. When using ANDSF for traffic steering, UE 102 may take QCI values that are pre-configured in ANDSF as guidance on whether to offload certain data flow to WLAN network 106 or not. In another example, the QCI could also be included in the WLAN preference pre-configured by the user. In this example, the user would need to know which QCI (s) to offload and would require the knowledge of QCIs to services mapping.

Additionally, it may not always be that part of a flow is offloaded to a particular technology while part of the flow is not. It may be that UE 102 does not offload any traffic or that UE 102 offloads all traffic. In the latter example, UE 102 may stay connected to both networks or do a complete handoff. In the example discussed above in connection with FIG. 2, if there is no conversational traffic, i.e., satisfying QCI<2, then all traffic present at UE 102 may be offloaded to WLAN network 106 and, alternatively, if there is only conversational traffic, i.e., satisfying QCI<2, then no offloading of traffic may take place. It will be appreciated by those skilled in the art that other scenarios are possible as well.

Systems, methods, devices, and computer-program products are contemplated to implement the features or aspects of the present disclosure. For example, a UE for selectively routing data traffic to one of a 3GPP network and a non-3GPP network is contemplated. The UE may include or comprise: a 3GPP network interface for communicating with the 3GPP network; a non-3GPP network interface for communicating with the non-3GPP network; a processor; and a memory element coupled with and readable by the processor and having stored therein processor-readable instructions that when executed by the processor cause the processor to detect receipt of a parameter via the 3GPP network interface that identifies a particular mode, selected from a plurality of modes, for selectively routing data traffic to one of the 3GPP network interface and the non-3GPP network interface based on particular QCI information.

It contemplated that the parameter may include or comprise one of: a bit value 00; a bit value 01; a bit value 10; and a bit value 11. Alternatively, a 3 bit or 4 bit scheme as discussed above may be utilized. In each example though, the processor may route particular data traffic to one of the 3GPP network interface and the non-3GPP network interface according to the particular mode, as specified by the bit value. For example, assume value 00=single QCI parameter as shown and discussed in connection with FIG. 2; bit value 01=range of QCI parameters in the form [QCI1, QCI2] as shown and discussed in connection with FIG. 3; bit value 10=set of QCI parameters in the form [QCI1, QCI2, . . . , QCIn] as shown and discussed in connection with FIG. 4. Other examples are possible as may be understood in light of the preceding disclosure.

However, it will thus be appreciated that in one example the particular mode may be based on a single QCI parameter, and the particular data traffic may be routed to one of the 3GPP network interface and the non-3GPP network interface based upon a comparison by the UE between a value of the single QCI parameter and a particular QCI value associated with the particular data traffic, whereby the one of the 3GPP network and the non-3GPP network may be selected based upon a value of a routing parameter of the particular QCI information, similar to that discussed above in connection with element 202 and element 204 of FIG. 2. Additionally, while element 202 and element 204 as shown and described above each have a particular number of fields or parameters, it is contemplated that one or both of element 202 and element 204 may be modified to exhibit more or fewer fields or parameters, in any particular combination or order, in accordance with the principles of the present disclosure.

In another example, the particular mode may be based on a range of QCI parameters, and the particular data traffic may be routed to one of the 3GPP network interface and the non-3GPP network interface based upon a comparison by the UE between a value of each QCI parameter at the limit of the range of QCI parameters and a particular QCI value associated with the particular data traffic, whereby the one of the 3GPP network and the non-3GPP network may be selected based upon a value of a routing parameter of the particular QCI information, similar to that discussed above in connection with element 302 and element 304 of FIG. 3. Additionally, while element 302 and element 304 as shown and described above each have a particular number of fields or parameters, it is contemplated that one or both of element 302 and element 304 may be modified to exhibit more or fewer fields or parameters, in any particular combination or order, in accordance with the principles of the present disclosure.

In another example, the particular mode may be based on a set of QCI parameters, and the particular data traffic may be routed to one of the 3GPP network interface and the non-3GPP network interface based upon a comparison by the UE between a value of each QCI parameter within the set of QCI parameters and a particular QCI value associated with the particular data traffic, whereby the one of the 3GPP network and the non-3GPP network may be selected based upon a value of a routing parameter of the particular QCI information, and whereby the QCI information may include a parameter that indicates a number of the QCI parameters within the set of QCI parameters for the UE to identify the QCI parameters within the set of QCI parameters, similar to that discussed above in connection with element 402 and element 404 of FIG. 4. Additionally, while element 402 and element 404 as shown and described above each have a particular number of fields or parameters, it is contemplated that one or both of element 402 and element 404 may be modified to exhibit more or fewer fields or parameters, in any particular combination or order, in accordance with the principles of the present disclosure.

Additionally, in some examples, the particular QCI information may include or comprise a traffic type parameter, a routing parameter, and a QCI parameter, and the particular data traffic may be routed to one of the 3GPP network interface and the non-3GPP network interface based upon a value of the routing parameter, a comparison between a value of the traffic type parameter and a particular traffic type value associated with the particular data traffic, and a comparison between a value of the QCI parameter and a particular QCI value associated with the particular data traffic, similar to that discussed above in connection with element 502 of FIG. 5. Additionally, while element 502 as shown and described above has a particular number of fields or parameters, it is contemplated that element 502 may be modified to exhibit more or fewer fields or parameters, in any particular combination or order, in accordance with the principles of the present disclosure.

Additionally, in some examples, the memory element may have stored therein processor-readable instructions that when executed by the processor cause the processor to detect receipt of the QCI information via the 3GPP network interface; and store the QCI information to the memory element. Accordingly, such QCI information and/or steering rules may be supplied to the UE from a 3GPP network. Other examples are possible.

For instance, a UE for selectively routing data traffic to one of a 3GPP network and a non-3GPP network is contemplated. The UE may include or comprise: a 3GPP network interface for communicating with the 3GPP network; a non-3GPP network interface for communicating with the non-3GPP network; a processor; and a memory element coupled with and readable by the processor and having stored therein processor-readable instructions that when executed by the processor cause the processor to selectively route data traffic to one of the 3GPP network interface and the non-3GPP network interface based on QCI indication information received by the UE via the 3GPP network interface, wherein the QCI indication information includes at least one parameter selected from the group consisting of: at least one particular QCI parameter; an action parameter; a traffic-type parameter; and a scheme selection parameter.

In this example, it is contemplated that the QCI indication information may correspond to QCI information in the ANDSF rules or in the RAN rules. Additionally, it is contemplated that the at least one particular QCI parameter may correspond to how QCI information is to be indicated, i.e., in what form. Specifically, through a single QCI parameter (threshold based rule), a range of values, or through a set of values, in a manner similar to that discussed above in connection with at least one of FIGS. 2-5. Additionally, it is contemplated that the action parameter may correspond to an indicator as to how to handle given QCI values, i.e., whether to offload traffic satisfying QCI criteria or not, in a manner similar to that discussed above in connection with at least one of FIGS. 2-5. Additionally, it is contemplated that the traffic-type parameter may correspond to an indicator so as to allow for different rules for different types of traffic, e.g., GBR versus non-GBR, in a manner similar to that discussed above in connection with at least one of FIGS. 2-5. Additionally, it is contemplated that the scheme selection parameter may correspond to an indicator so as to allow for a choice among different schemes, e.g., threshold, range, set of QCI parameters, Action, Traffic Type, etc., by using 2-bit or x-bit signaling, in a manner similar to that discussed above in connection with at least one of FIGS. 2-5.

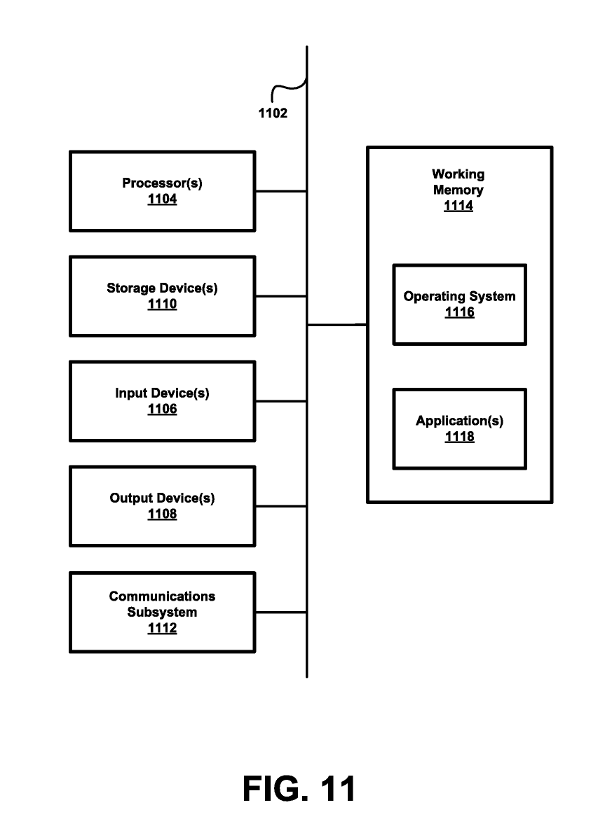

FIG. 11 shows an example computer system or device 1100. The computer device 1100 is shown comprising hardware elements that may be electrically coupled via a bus 1102 (or may otherwise be in communication, as appropriate). The hardware elements may include a processing unit with one or more processors 1104, including without limitation one or more general-purpose processors and/or one or more special-purpose processors (such as digital signal processing chips, graphics acceleration processors, and/or the like); one or more input devices 1106, and one or more output devices 1108.

The computer system 1100 may further include (and/or be in communication with) one or more non-transitory storage devices 1110, which may comprise, without limitation, local and/or network accessible storage, and/or may include, without limitation, a disk drive, a drive array, an optical storage device, a solid-state storage device, such as a random access memory, and/or a read-only memory, which may be programmable, flash-updateable, and/or the like. Such storage devices may be configured to implement any appropriate data stores, including without limitation, various file systems, database structures, and/or the like.

The computer device 1100 might also include a communications subsystem 1112, which may include without limitation a modem, a network card (wireless and/or wired), an infrared communication device, a wireless communication device and/or a chipset such as a Bluetooth™ device, 802.11 device, WiFi device, WiMax device, cellular communication facilities such as GSM, W-CDMA, LTE, etc. The communications subsystem 1112 may permit data to be exchanged with a network (such as the network described below, to name one example), other computer systems, and/or any other devices described herein. In many examples, the computer system 1100 will further comprise a working memory 1114, which may include a random access memory and/or a read-only memory device, as described above.

The computer device 1100 also may comprise software elements, shown as being currently located within the working memory 1114, including an operating system 1116, device drivers, executable libraries, and/or other code, such as one or more application programs 1118, which may comprise computer programs provided by various examples, and/or may be designed to implement methods, and/or configure systems, provided by other examples, as described herein. By way of example, one or more procedures described with respect to the method(s) discussed above, and/or system components might be implemented as code and/or instructions executable by a computer (and/or a processor within a computer); in an aspect, then, such code and/or instructions may be used to configure and/or adapt a general purpose computer (or other device) to perform one or more operations in accordance with the described methods.

A set of these instructions and/or code might be stored on a non-transitory computer-readable storage medium, such as the storage device(s) 1110 described above. In some cases, the storage medium might be incorporated within a computer system, such as computer system 1100. In other examples, the storage medium might be separate from a computer system (e.g., a removable medium, such as flash memory), and/or provided in an installation package, such that the storage medium may be used to program, configure, and/or adapt a general purpose computer with the instructions/code stored thereon. These instructions might take the form of executable code, which is executable by the computer device 1100 and/or might take the form of source and/or installable code, which, upon compilation and/or installation on the computer system 1100 (e.g., using any of a variety of generally available compilers, installation programs, compression/decompression utilities, etc.), then takes the form of executable code.

It will be apparent that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As mentioned above, in one aspect, some examples may employ a computer system (such as the computer device 1100) to perform methods in accordance with various examples of the disclosure. According to a set of examples, some or all of the procedures of such methods are performed by the computer system 1100 in response to processor 1104 executing one or more sequences of one or more instructions (which might be incorporated into the operating system 1116 and/or other code, such as an application program 1118) contained in the working memory 1114. Such instructions may be read into the working memory 1114 from another computer-readable medium, such as one or more of the storage device(s) 1110. Merely by way of example, execution of the sequences of instructions contained in the working memory 1114 may cause the processor(s) 1104 to perform one or more procedures of the methods described herein.

The terms “machine-readable medium” and “computer-readable medium,” as used herein, may refer to any non-transitory medium that participates in providing data that causes a machine to operate in a specific fashion. In an example implemented using the computer device 1100, various computer-readable media might be involved in providing instructions/code to processor(s) 1104 for execution and/or might be used to store and/or carry such instructions/code. In many implementations, a computer-readable medium is a physical and/or tangible storage medium. Such a medium may take the form of a non-volatile media or volatile media. Non-volatile media may include, for example, optical and/or magnetic disks, such as the storage device(s) 1110. Volatile media may include, without limitation, dynamic memory, such as the working memory 1114.

Example forms of physical and/or tangible computer-readable media may include a floppy disk, a flexible disk, hard disk, magnetic tape, or any other magnetic medium, a compact disc, any other optical medium, ROM, RAM, and etc., any other memory chip or cartridge, or any other medium from which a computer may read instructions and/or code. Various forms of computer-readable media may be involved in carrying one or more sequences of one or more instructions to the processor(s) 1104 for execution. By way of example, the instructions may initially be carried on a magnetic disk and/or optical disc of a remote computer. A remote computer might load the instructions into its dynamic memory and send the instructions as signals over a transmission medium to be received and/or executed by the computer system 1100.

The communications subsystem 1112 (and/or components thereof) generally will receive signals, and the bus 1102 then might carry the signals (and/or the data, instructions, etc. carried by the signals) to the working memory 1114, from which the processor(s) 1104 retrieves and executes the instructions. The instructions received by the working memory 1114 may optionally be stored on a non-transitory storage device 1110 either before or after execution by the processor(s) 1104. It should further be understood that the components of computer device 1100 can be distributed across a network. For example, some processing may be performed in one location using a first processor while other processing may be performed by another processor remote from the first processor. Other components of computer system 1100 may be similarly distributed. As such, computer device 1100 may be interpreted as a distributed computing system that performs processing in multiple locations. In some instances, computer system 1100 may be interpreted as a single computing device, such as a distinct laptop, desktop computer, or the like, depending on the context.

The features or aspects of the present disclosure discussed above are examples. Various configurations may omit, substitute, or add various method steps or procedures, or system components as appropriate. For instance, in alternative configurations, the methods may be performed in an order different from that described, and/or various stages or steps or modules may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those of skill with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations may be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Furthermore, the examples described herein may be implemented as logical operations in a computing device in a networked computing system environment. The logical operations may be implemented as: (i) a sequence of computer implemented instructions, steps, or program modules running on a computing device; and (ii) interconnected logic or hardware modules running within a computing device.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A UE (User Equipment) for selectively routing data traffic to one of a 3GPP (3^{rd} Generation Partnership Project) network and a non-3GPP network, the UE comprising:
a 3GPP network interface for communicating with the 3GPP network;
a non-3GPP network interface for communicating with the non-3GPP network;
a processor; and
a memory element coupled with and readable by the processor and having stored therein processor-readable instructions that when executed by the processor cause the processor to:
detect receipt of a data structure via the 3GPP network interface that comprises an indicator parameter, an action parameter, and a plurality of QCI (Quality of Service Class Indicator) parameters for selectively routing data traffic to one of the 3GPP network interface and the non-3GPP network interface, wherein:
the indicator parameter is an integer value, N, equal to a number of parameters contained in the plurality of QCI parameters; and
the action parameter is a string of N bits, wherein each of the N bits corresponds to one of the plurality of QCI parameters, and wherein each of the N bits indicates whether data traffic associated the corresponding QCI parameter is routed to the 3GPP network interface or the non-3GPP network interface; and
route particular data traffic to one of the 3GPP network interface and the non-3GPP network interface according to the data structure and particular QCI information associated with the particular data traffic.

2-9. (canceled)

10. The UE of claim 1, wherein the memory element having stored therein processor-readable instructions that when executed by the processor cause the processor to:
store the data structure to the memory element.

11. A method for selectively routing data traffic to one of a 3GPP (3^{rd} Generation Partnership Project) network and a non-3GPP network, comprising:
receiving, by a UE (User Equipment), a data structure via a 3GPP network interface that comprises an indicator parameter, an action parameter, and a plurality of QCI (Quality of Service Class Indicator) parameters for selectively routing data traffic to one of the 3GPP network interface and a non-3GPP network interface, wherein:
the indicator parameter is an integer value, N, equal to a number of parameters contained in the plurality of QCI parameters; and
the action parameter is a string of N bits, wherein each of the N bits corresponds to one of the plurality of QCI parameters, and wherein each of the N bits indicates whether data traffic associated the corresponding QCI parameter is routed to the 3GPP network interface or the non-3GPP network interface; and
routing, by the UE, particular data traffic to one of the 3GPP network interface and the non-3GPP network interface according to the data structure and particular QCI information associated with the particular data traffic.

12-19. (canceled)

20. The method of claim 11, further comprising:
storing the particular QCI information to a memory element of the UE.

21. (canceled)
